(19) United States
(12) Patent Application Publication
(10) Pub. No.: US 2003/0090038 A1
(43) Pub. Date: May 15, 2003

(54) Manufacturing method and drying device for ceramic honeycomb form

(76) Inventors: Satoshi Ishikawa, Anjo-City (JP); Shoichi Goto, Nagoya-City (JP); Hiromi Katou, Kuwana-City (JP)

Correspondence Address: Nixon & Vanderhye P.C., 8th Floor, 1100 North Glebe Road, Arlington, VA, 22201-4714, US

(21) Appl. No.: 10/284,343

(22) Filed: Oct. 31, 2002

(30) Foreign Application Priority Data
Nov. 9, 2001 (JP) 2001-344463

(51) Int. Cl. H05B 6/64; C04B 33/32

(52) U.S. Cl. 264/432; 264/630; 219/700; 219/762

(57) ABSTRACT

The present invention manufactures a ceramic honeycomb structure, and includes an extrusion process for forming the honeycomb form, a cutting process for cutting the honeycomb form into predetermined lengths, a drying process for drying the honeycomb form, and a firing process for firing the honeycomb form, a heating step with a honeycomb form arranged with its axis inclined away from the vertical and a rotating step for changing the arrangement of the honeycomb form by rotating it being alternated in the drying process.

### BACKGROUND OF THE INVENTION

1. Field of the Invention

The present invention relates to a manufacturing method for a honeycomb form, in particular to a drying process and drying device therefor.

2. Description of the Related Art

Ceramic honeycomb structures having an external shell provided by partitioning the shell into a plurality of cells are used as catalyst supports for exhaust gas filters for automobiles, for example.

In manufacturing the above ceramic honeycomb structures, firstly, a soft honeycomb form formed by extruding kneaded ceramic material through a honeycomb shape is cut to a desired length. Next, the honeycomb form is dried by microwave heating or the like. Then, the dried honeycomb form is fired to produce a ceramic honeycomb structure.

The above extruded formation is usually performed by means of a horizontal extrusion method, which is one formation method for ceramic bodies such as ceramic tubes, ceramic rods, and the like. As described hereafter, manufacture using, for example, an extrusion formation device comprising a formation die for forming the honeycomb form, and a screw extrusion machine for continuously kneading and extruding the ceramic material, is usual.

Because this honeycomb form immediately after extrusion formation includes water and is therefore weak, deformation during the subsequent drying process is a problem. In particular, because in recent years the thickness of the partitions and external shell have been reduced in order to meet the requirements of improving exhaust gas filtering performance and the like, this problem has become more noticeably.

As a drying process, there is a method of drying the honeycomb form, extruded horizontally as described above, in its horizontal state as it is extruded. However, with this method, there is still the problem of deformation of the honeycomb form during drying. The reason for this deformation is thought to be the following.

As shown in FIG. 12, a contraction force 85 generated by contraction during the drying process and a reaction force 86 due to self-weight occur in the honeycomb form 83. This contraction force 85 is the inward force in the circumferential direction operating on those areas of the honeycomb form 83 that are not yet dry, on the periphery of the drying region 89. Also, the reaction force 86 due to self-weight operates in the inward direction from the surface where the honeycomb form 83 is in contact with the pedestal 88, and its strength increases towards the bottom of the honeycomb form 83.

Consequently, the combined force of the above contraction force 85 and reaction force 86 is at its maximum at the not yet dry areas on the periphery of the drying region, which is the lower portion of the honeycomb form 83. As a result, where the honeycomb form 83 is dried in a horizontal state, there are the deficiencies of breakage, distortion, collapse, and the like in the lower portion of the honeycomb form 83.

Here, a method of drying the honeycomb form in a state where the entire periphery of the honeycomb form is covered by means of a jig divided into upper and lower sections (Unexamined Patent Publication (Kokai) No. 2001-19533) has been proposed in order to prevent deformation when drying a honeycomb form in a horizontal state. In this drying method, the lower jig supports the honeycomb form and the upper jig is mounted on the honeycomb form. In this state, it is thought that the amount of water evaporating from the periphery of the honeycomb form during drying can be controlled and the drying state uniformly maintained, so that the effect of reducing the contraction force generated during drying can be achieved. However, not only does this method ignore the reaction force due to self-weight, but the weight of the upper jig is added to the honeycomb form. As a result, in a honeycomb form whose external shell thickness has been reduced in particular, deformation during the drying process cannot be prevented.

On the other hand, if the honeycomb form is dried in a vertical state, the contraction force operating in the circumferential direction of the honeycomb form and the reaction force operating in the axial direction of the honeycomb form are perpendicular to each other. As a result, in the circumferential direction of the honeycomb form, the large resultant force that results in cell defects does not occur. Also, the reaction force due to self-weight described above operates uniformly across the cross-section of the honeycomb form, and is imposed on all of the cell walls. Consequently, if the honeycomb form is sufficiently short in the axial direction, this force will not lead to deformation.

For the above reasons, drying of honeycomb forms is generally carried out with the honeycomb form in a vertical state.

However, in order to dry the honeycomb form in a vertical state, the honeycomb form extruded by horizontal extrusion must first be cut sufficiently short. Then, the honeycomb form must be held and stood upright by some kind of method. This type of process of handling the weak honeycomb form and altering its shape prior to drying not only leads to increased complexity in the manufacturing process and therefore decreases manufacturing efficiency, but also imposes stress on the weak honeycomb form. As a result, the danger of this leading to deficiencies such as distortion, breakage and the like in the cells of the honeycomb form is high.

### SUMMARY OF THE INVENTION

The present invention, in light of the problems of the relevant prior art, provides a honeycomb form manufacturing method and manufacturing device that do not cause deformation of weak honeycomb forms after formation when drying them in a state where they are positioned so that their axes are inclined away from the vertical.

A first embodiment of the present invention is a ceramic honeycomb structure manufacturing method comprising an extrusion process for forming a honeycomb form having an external shell, partitions arranged within the external shell in a honeycomb formation, and a plurality of cells divided inside the partitions and formed along the axial direction so as to pass through both ends, by extrusion forming a ceramic raw material made by kneading at least a raw material powder and water; a cutting process for cutting the honeycomb form into predetermined lengths; a drying process for drying the honeycomb form; and a firing process for firing the honeycomb form to attain a ceramic honeycomb structure, wherein, in the drying process, a heating step for applying heat in a state where the honeycomb form is arranged so that its axis is inclined in a direction away from the vertical and the honeycomb form is held stationary in the direction of rotation of the axis, and a rotating step for changing the arrangement of the honeycomb form by rotating the honeycomb form around its axis between each of a plurality of executions of the heating step, are performed.

The first embodiment of the present invention performs the above heating step and rotating step in combination in the drying process. The heating step is a step for performing heating with the honeycomb form arranged so that its axis is inclined in a direction away from the vertical and in a state where it is held stationary in the direction of rotation of the axis. Also, the rotating step is a step for rotating the honeycomb form around its axis while the heating step is executed a plurality of times and changing this arrangement between each heating step.

As a result, in the above drying process, drying contraction due to heating and changing of the arrangement of the honeycomb form are repeatedly performed. Consequently, each time the honeycomb form's arrangement is changed, the location where the resultant force of the reaction force due to self-weight and the contraction force operate is shifted.

Accordingly, the effect of the above resultant force on the honeycomb form is uniform and reduced, and deformation of the honeycomb form can be controlled.

As described above, according to the first embodiment of the present invention, a manufacturing method for producing a honeycomb form without deformation can be provided even where a weak honeycomb form after forming is dried in a state where its axis is arranged in a direction inclined away from the vertical.

A second embodiment of the present invention is a honeycomb form manufacturing method comprising an extrusion process for forming a honeycomb form having an external shell with a maximum thickness of 0.8 mm, partitions arranged within the external shell in a honeycomb formation with a maximum thickness of 150 μm, and a plurality of cells divided inside the partitions and formed along the axial direction so as to pass through both ends, by extrusion forming a ceramic raw material made by kneading at least a raw material powder and water; a cutting process for cutting the honeycomb form into predetermined lengths; a drying process for drying the honeycomb form; and a firing process for firing the honeycomb form to attain a ceramic honeycomb structure, wherein, in the drying process, a heating step for performing microwave heating in a state where the honeycomb form is mounted on a sponge shaped pedestal for supporting part of the external shell of the honeycomb form so that its axis is substantially horizontal and the honeycomb form is held stationary in the direction of rotation of the axis, and a rotating step for changing the arrangement of the honeycomb form by rotating the honeycomb form around its axis between each of a plurality of executions of the heating step, are performed.

The second embodiment of the present invention manufactures an extremely thin-walled honeycomb form having an external shell of 0.8 mm or less and partitions of a thickness of 150 μm arranged within the external shell in a honeycomb formation. Then, in the above drying process, a heating step is performed wherein the honeycomb form is heated in a state where it is arranged so that its axis is in a substantially horizontal state, and it is held stationary in the direction of rotation of its axis. Further, between each of a number of executions of the heating step, a rotating step is performed in which the arrangement of the honeycomb form is changed by rotating it around its axis.

As a result, as in the first embodiment, drying contraction due to heating and changing of the arrangement of the honeycomb form are repeatedly performed. Consequently, each time the honeycomb form's arrangement is changed, the location where the resultant force of the reaction force due to self-weight and the contraction force operate is shifted.

Accordingly, the effect of the above resultant force on the honeycomb form is uniform and reduced, and deformation of the honeycomb form can be controlled.

Also, in the second embodiment, in the drying process, drying is performed by microwave heating. These microwaves differ from heat application by high frequency waves as in the prior art, and can be guided through a wave guide, so that disposing electrodes in the vicinity of the honeycomb form is unnecessary. Consequently, the application of a high temperature atmosphere, high humidity atmosphere, and the like is easy.

Accordingly, even with a honeycomb form having extremely thin cell walls of 150 μm or less and a relatively thin external shell of 0.8 mm or less, rapid drying can be prevented by drying the honeycomb form in a high temperature, high humidity atmosphere. In other words, breakage and wrinkling of the external wall resulting from rapid drying can be prevented.

As described above, in the second embodiment of the present invention, a manufacturing method for producing a honeycomb form without deformation can be provided even where an extremely weak honeycomb form having extremely thin cell walls of 150 μm or less and a relatively thin external shell of 0.8 mm or less is dried in a state where it is substantially horizontal.

A third embodiment of the present invention is a ceramic honeycomb structure drying device for drying a honeycomb form having an external shell, partitions arranged within the external shell in a honeycomb formation, and a plurality of cells divided inside the partitions and formed along the axial direction so as to pass through both ends, comprising transport means for conveying the honeycomb form by mounting the honeycomb form on a pedestal that supports part of its external shell so that the axis of the honeycomb form is substantially horizontal, a heating device for heating the honeycomb form by means of microwave heating, and a rotating device for changing the arrangement of honeycomb form by rotating it around the its axis, wherein the honeycomb form is sequentially transported to the heating device and the rotating device by the transport means, a heating step for applying heat in a state where the honeycomb form is held stationary in the direction of rotation of its axis in the heating device, and a rotating step for rotating the honeycomb form in the rotating device between each of a plurality of executions of the heating step, are performed.

The drying device according to the third embodiment, as described above, has the above transport means, heating device, and rotating device. Also, by using each of these devices, it is able to perform the above heating step and rotating step.

As a result, as in the first embodiment, drying by means of heating and the honeycomb form's arrangement can be repeatedly changed using the drying device of the third embodiment of the present invention.

Accordingly, deformation of the honeycomb form can be controlled.

Also, the heating device in the above drying device employs microwave heating. These microwaves, as described above, differ from heating with high frequency waves as in the prior art, and can be guided through a wave guide, so that disposing electrodes in the vicinity of the honeycomb form is unnecessary. Consequently, the application of a high temperature atmosphere, high humidity atmosphere, and the like is easy.

Accordingly, rapid drying can be prevented by drying the honeycomb form in a high temperature, high humidity atmosphere. In other words, breakage and wrinkling of the external wall resulting from rapid drying can be prevented.

As described above, according to the third embodiment of the present invention, a honeycomb form drying device that does not generate deformation in an extremely weak honeycomb form even when drying it in a state where it is arranged substantially horizontally, can be provided.

The present invention may be more fully understood from the description of preferred embodiments of the invention set forth below, together with the accompanying drawings.

### BRIEF DESCRIPTION OF THE DRAWINGS

In the drawings:

FIG. 1 is a process flow chart showing the manufacturing processes of a ceramic honeycomb structure in the embodiments;

FIG. 2 is a perspective view showing the honeycomb form in the embodiments;

FIG. 3 is a is an enlarged view of the section A-A in FIG. 2, showing the honeycomb form in the embodiments;

FIG. 4 is a sectional view showing an extrusion forming device used in the embodiments;

FIG. 5 is a front view showing a form cutting device used in the embodiments;

FIG. 6 is a front view showing a drying device used in the embodiments;

FIG. 7 is a front view showing a pedestal used in the embodiments;

FIG. 8 is a side view showing a pedestal used in the embodiments;

FIG. 9 is a sectional view showing a heating device used in the embodiments;

FIG. 10 is a sectional view showing a rotating device used in the embodiments;

FIG. 11 is a perspective view showing the ceramic honeycomb structure of the embodiments; and

FIG. 12 is a model view showing the causes of deformation of a honeycomb form during drying in the prior art.

### DESCRIPTION OF THE PREFERRED EMBODIMENTS

A first embodiment of the present invention will be explained.

In the first embodiment, a variety of heating methods such as microwave heating, high frequency heating, hot air heating and the like can be utilized as the above heating method.

Also, in the drying process, it is preferable to arrange the honeycomb form substantially horizontal to perform the heating step and rotating step.

In this case, the honeycomb form extruded in the horizontal direction in the extrusion process can be moved to the drying process without any deformation in the axial direction. As a result, the operational effects of being able to simplify the manufacturing devices and minimizing the amount of stress imposed on the honeycomb form can be attained.

Also, in the rotating step, it is preferable to rotate the honeycomb form within a range of 90° to 270°.

If the above rotation is less than 90° and over 270°, there is the possibility that the effect of reducing the operation of the resultant force of the contracting force occurring during drying and the reaction force due to self-weight may be lessened. As a result, it is even more preferable to make the range of rotation between 120° and 240°.

Also, it is preferable to set the temperature of the heating step to 180° if it performed twice, and 120° is it is performed three times. In this case, the portions disposed at the lowermost part of the honeycomb form are arrayed uniformly in their angular direction. In other words, even if the number of times that the arrangement of the honeycomb form is changed is low, the arrangement can be changed while maintaining a balance. Accordingly, even if the honeycomb form is dried in a horizontal state, the operational effect of not causing ay deformation can be achieved.

Moreover, in the above heating step, it is preferable to heat the honeycomb form by means of microwave heating.

In such a case, it is possible to guide the microwaves through a wave guide, and it is unnecessary to arrange electrodes in the vicinity of the honeycomb form. As a result, when it is necessary to heat the honeycomb form in a high temperature, high humidity atmosphere, the operational effect of not requiring a complex equipment structure can be achieved.

Further, in the above heating step, the honeycomb form can be heated by means of high frequency heating.

In such a case, because drying of the honeycomb form progresses uniformly, the contraction force that occurs due to differences in drying speeds is small. As a result, the operational effect of deformation of the honeycomb form caused by the contraction force generated by the drying process not occurring can be attained.

Furthermore, while performing the heating step, it is preferable to mount the honeycomb form on a sponge-shaped pedestal for supporting part of the external shell.

In this case, it is possible for water to scatter into the contact surface between the honeycomb form and the pedestal, but this does not interfere with the drying of the honeycomb form. As a result, the operational effect of the contraction force due to differences in the drying speed of the honeycomb form being reduced and deformation arising from this contraction force being averted, can be achieved.

Further still, it is preferable to mount the honeycomb form on the sponge-shaped pedestal such that part of the partitions are substantially perpendicular.

In such a case, the operational effect of increasing the strength of the honeycomb form in the vertical direction, which is the direction in which weight operates, can be achieved.

Moreover, it is preferable to make the thickness of the external shell of the honeycomb form 0.8 mm or less, and the thickness of the partitions 150 μm or less.

In this case, the strength of the honeycomb form is extremely low and deformation during the drying process can easily occur. Therefore, the operational effects attained by the method the first embodiment are particularly effective.

In the third embodiment of the present invention, it is preferable for the drying device to have a plurality of the heating devices, and for the heating devices and rotating device to be alternately disposed on a conveyor line of the transport device.

In this case, after being formed by the extrusion device, each step of the drying process can be continuously executed simply by passing the honeycomb form along a conveyor line. As a result, the operational effect of being able to efficiently perform drying of the honeycomb form can be attained.

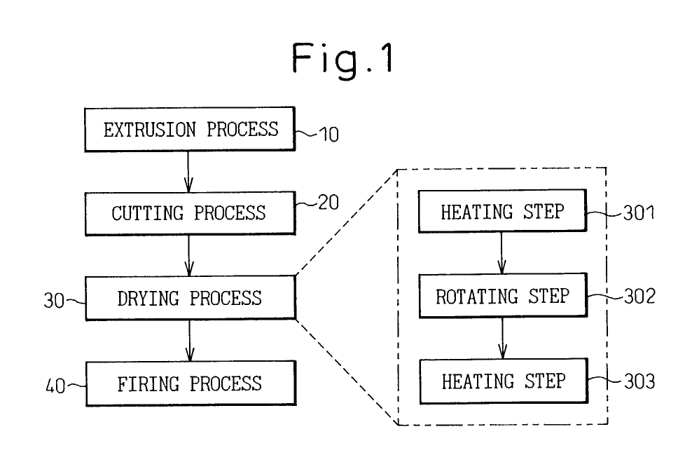

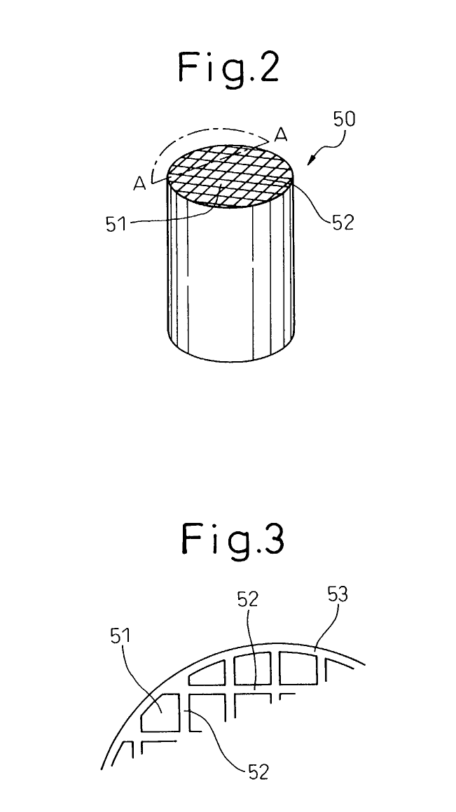

The ceramic honeycomb structure manufacturing method and drying device according to the embodiment of the present invention will be explained with reference to FIGS. 1 to 11.

The present embodiment, as shown in FIG. 1, is an example of a manufacturing method for a ceramic honeycomb structure, which comprises an extrusion process 10, a cutting process 20, a drying process 30 comprising a plurality of heating steps 301 and 303, and a rotating step 302 continuously executed between the heating steps, and a firing process 40.

The extrusion process 10 is a process for forming a honeycomb form 50 by extrusion forming a ceramic material 180 made by kneading a mixture of at least a raw material powder and water.

The cutting process 20 is a process for cutting the honeycomb form 50 into predetermined lengths.

The drying process 30 is a process for drying the honeycomb form 50. The heating steps 301 and 303 included in the drying process 30 are steps for heating the honeycomb form in a state where it is arranged so that its axis is inclined in a direction away from the vertical and it is held stationary in the direction of rotation of its axis. Also, the rotating step 302 included in the drying process 30 is a step for changing the arrangement of the honeycomb form by rotating the honeycomb form around its axis between the first heating step 301 and the second heating step 303.

The firing process 40 is a step for attaining a ceramic honeycomb structure 1 by firing the honeycomb form 50. Hereafter, the content of the present embodiment will be explained.

Firstly, as shown in FIG. 11, the ceramic honeycomb structure 1 has a structural external shell 104 whose thickness is 0.8 mm or less, structural partitions 101 arranged in a honeycomb shape within the structural external shell 104 and having a thickness of 150 μm or less, and a plurality of structural cells 108 divided within the structural partitions 101 and formed along the axial direction so that they pass through both ends.

Also, the shapes of the structural cells 108 and the external shape of the ceramic honeycomb structure 1 are adaptable to meet their application.

In the extrusion process 10, a clay honeycomb form 50, having an external shell 53 whose thickness is 0.8 mm or less, partitions 52 arranged in a honeycomb shape and having a thickness of 150 μm or less, and a plurality of cells 51 divided within the structural partitions 101 and formed along the axial direction so that they pass through both ends, is produced.

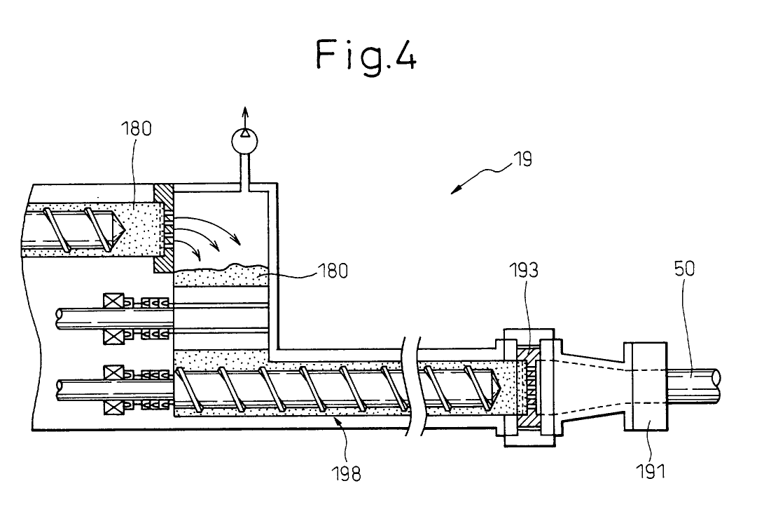

Here, the extrusion process 10 is performed using the extrusion forming device 19 shown in FIG. 4. This extrusion forming device 19 has a forming die 191 for forming the honeycomb form 50, and a screw extruding machine 198 for continuously kneading and-extruding a ceramic material 180.

Firstly, in performing the extrusion process 10, 5 weight units of an organic binder and 15 weight units of water are mixed and kneaded with 100 weight units of a ceramic raw material powder of mainly cordierite to prepare a claylike ceramic material 180. Then, using the screw extruding machine 198, the ceramic material 180 is extruded from the honeycomb forming die 191 to form a claylike honeycomb form 50. Also, a plunger type extruding machine, auger type extruding machine or the like can be used as the extruding machine 19.

Next, in the cutting process 20, the honeycomb form 50 produced by the extrusion process 10 is cut into predetermined lengths. Here, these predetermined lengths are set to a length which is a length for chamfering, described below, added to the length of the ceramic honeycomb structure 1 which is the completed product.

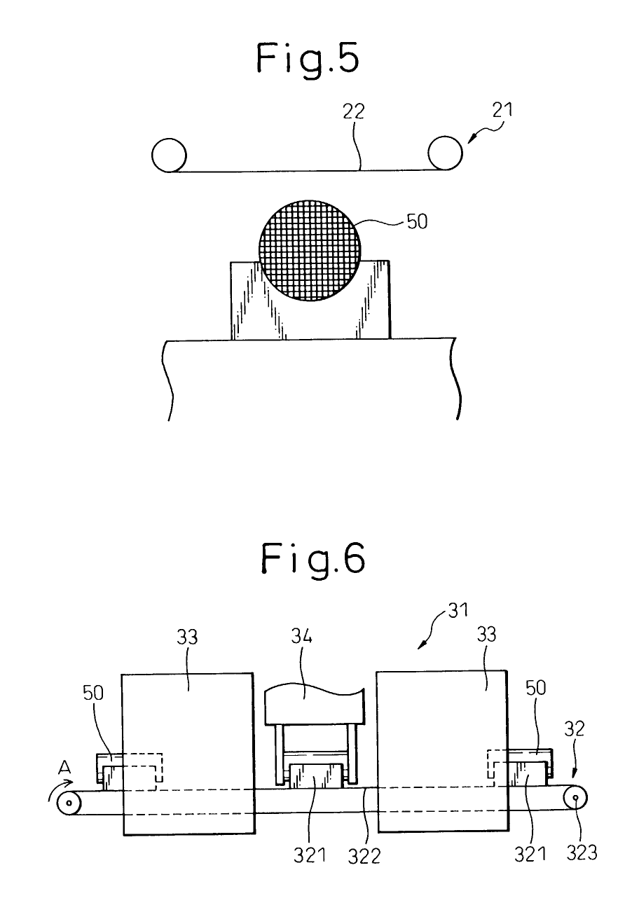

In this cutting process 20, the form cutting device 21 shown in FIG. 5 is used. This form cutting device 21 has a cutting wire 22 that travels in a direction substantially perpendicular to the axial direction of the honeycomb form.

Next, in the drying process 30 drying of the honeycomb form 50 cut to a predetermined length by the cutting process 20 is performed. Here, an explanation of the drying process will be given.

Firstly, the drying device 31 employed in the drying process 30 will be explained using FIG. 6. This drying device 31 is an example of a drying device for the honeycomb form 50, and includes transport means 32, two heating devices 33,, and a rotating device 34.

The transport means 32 is means for mounting the honeycomb form 50 on a pedestal 321 for supporting part of the external shell 53 so that its axis is substantially horizontal, and transporting the honeycomb form 50 in the direction of arrow A.

The heating devices 33 are devices for drying the honeycomb form 50 by means of microwave heating.

The rotating device 34 is a device for rotating the honeycomb form 50 supported on the pedestal 321 around its axis to change its disposition state. Herebelow, the content of these devices will be explained.

The transport means 32 comprises a belt conveyor 322 and roller conveyors 323, the belt type or loop type belt conveyor 322 is stretched with a fixed tensile strength by the roller conveyors 323-arranged at both ends thereof. When the roller conveyors 323 rotate, the rotary force thereof is transferred to the belt conveyor 322, and the belt conveyor 322 moves in its lengthwise direction.

Then, the transport means 32 is connected by a single belt conveyor 322 from the start till the finish of the drying process 30. Accordingly, when the honeycomb form 50 is mounted on and conveyed by the transport means 32, all of the steps of the drying process are continuously and automatically applied to the honeycomb form 50. At this time, the honeycomb form 50 is transported in a state where it is supported by the pedestal 321.

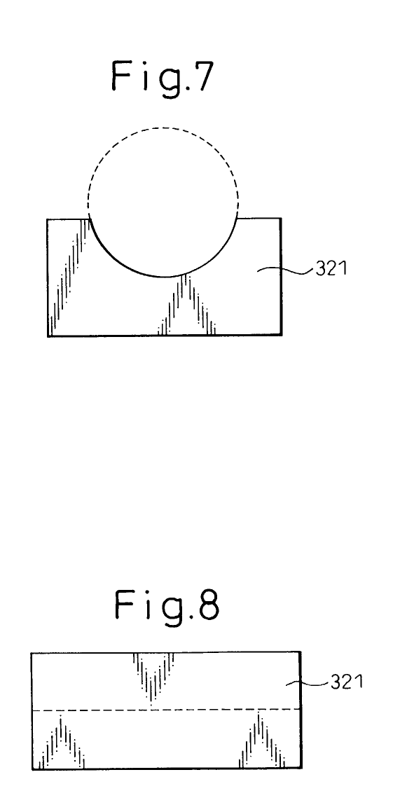

As shown in FIG. 7 and FIG. 8, a sponge-like porous material which is made from melamine resin is employed as the pedestal 321 in this embodiment. The shape thereof is processed to a shape that matches the external shape of the honeycomb form 50. Here, the use of a sponge-like porous material has been determined so that the scattering of water contained in the honeycomb form 50 is not hindered. Also, the shape of the pedestal 321 has been determined so that the contact surface area with the honeycomb form 50 is wide and the contact surface pressure is low.

Also, for reference, the material of the pedestal 321 can be another material as long as its temperature increase when exposed to microwave heating is lower than the temperature increase of the ceramic form itself. Specifically, as the material of the pedestal 321, a material whose dissipation factor (product of relative permittivity and tan δ) with respect to microwaves is smaller than the dissipation factor of the ceramic material is suitable. Since the lower the dissipation factor, the more easily a temperature increase during microwave heating can be controlled, the temperature of the pedestal 321 can be kept lower than the temperature of the ceramic honeycomb form 50. As well as the melamine resin used in the present embodiment, Teflon (registered trademark) resin, mica resin, alumina resin, polyethylene resin, silicon resin and the like can be considered.

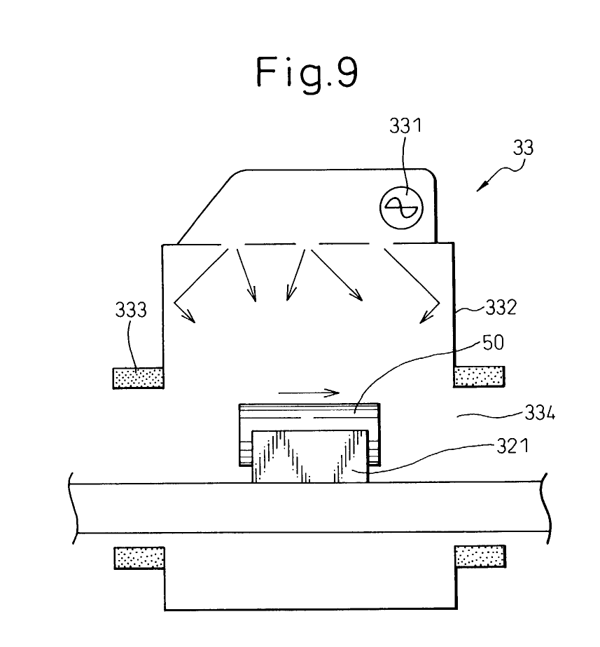

Further, the heating device 33, as shown in FIG. 9, comprises a microwave radiator 331, a wave guide (not shown), a drying tank 332 disposed so as to enclose the belt conveyor, and a humidifier (not shown) for creating a high temperature, high humidity atmosphere inside the drying tank 332. In the heating device 33, microwaves generated by the microwave radiator 331 are emitted to heat the honeycomb form 50.

The microwave radiator 331 used in the present embodiment has an oscillation frequency of 2,450 MHz ±50 MHz, and a nominal output of 5 kw. Also, at both sides of the drying tank 332, opening portions 334, which are sufficiently large enough for the honeycomb form 50 to pass through, are provided, and are normally open. As a result, wave absorbers 333 are provided around the opening portions 334 to prevent wave leakage.

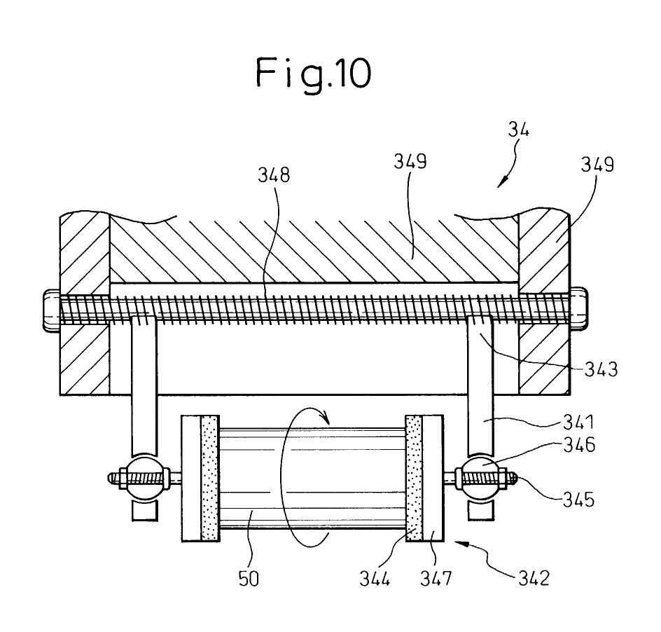

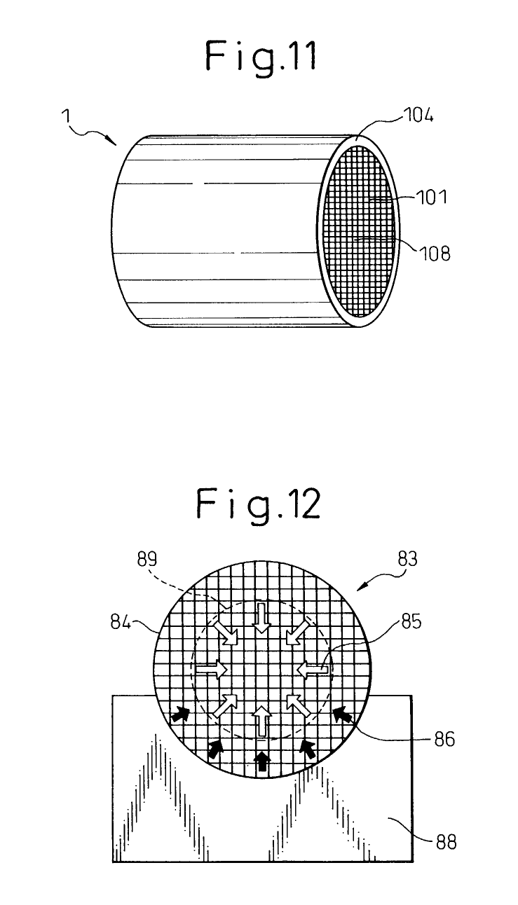

Also, the rotating means 34, as shown in FIG. 10, comprises an arm holder 349, connected to a hydraulic actuator (not shown), for performing up and down movement, arms 341 for supporting and raising the honeycomb form 50, chuck plates 342 for chucking both sides of the honeycomb form 50, and a worm gear 348 for moving the arm back and forth horizontally.

Here, because the worm gear portion 348 at the top of the right and left arms 341 has reverse gearing, the right and left arms 341 move symmetrically. As a result, the arms 341 move back and forth so that the gap therebetween increases or decreases depending on the rotation of the worm gear 348.

Further, the chuck plates 342 have metal plates 347 covered by soft sponge type pads 344, and axle portions 345. These axle portions 345 are connected to each arm 341 via a pillow ball joint 346. Consequently, the chuck plates 342, as well as being able to change freely in the direction of the surfaces of the pads 344, can rotate by means of motors (not shown).

Here, the pillow ball joint is also known as a spherical slide bearing. This pillow ball joint is a joint structure has a member having a convex spherical curved surface and a member having a concave spherical curved surface, and these are slidably fitted together via these spherical surfaces. Accordingly, the pillow ball joint enables axial rotation about an axial point, changes in the axial direction, and the like to be freely performed.

The content of the processes performed by the drying device 31 constructed as described above will now be explained.

The honeycomb form 50 transported to the drying device 31 is sequentially introduced into the two heating devices 33 and the rotating device 34 installed in the drying device 30, by means of the transporting means 32.

Firstly, in the heating device 33 having the above structure, the first heating step 301 is performed. In the first heating step 301, the honeycomb form 50 introduced into the drying tank 332 moves from the entrance side to the exit side together with the belt conveyor 322.

During this time, the honeycomb form 50 inside the heating device 33 is heated and dried by being irradiated by microwaves.

Also, in the drying tank, a high temperature, high humidity atmosphere is maintained by the humidifier (not shown). As a result, rapid drying of the honeycomb form 50 is prevented, so that defects of the external shell such as breakage, wrinkling and the like due to differences in drying rate can be prevented.

Then, the rotating step 302 is initiated in the rotating device 34 constructed as described above.

Here, firstly, a position sensor (not shown) detects the position of the honeycomb form 50. Then, the arms 341 of the rotating device 34 are lowered, and the chuck plates 342 enclose and hold both ends of the honeycomb form 50.

Here, because the surfaces of the chuck plates 342 are covered by the soft sponge material, they can softly respond to surface irregularities in the ends of the honeycomb form 50. Also, because the chuck plates 342 are connected to the arms 341 via the pillow balls 346, they can appropriately respond to inclinations in the ends of the honeycomb form 50.

The supported honeycomb form 50 is then lifted off the pedestal 321, and rotated 180° about its axis by means of the motors (not shown) connected to the axle portions 345 of the chuck plates 342. Then, the honeycomb form 50 is returned to the pedestal 321.

The disposition of the honeycomb form is changed as described above. Specifically, that part of the external shell 53 of the honeycomb form 50 that was in contact with the pedestal 321 in the first heating step 301 and is not yet dry is exposed in the upward direction.

Further, in the heating device 33 constructed as described above, the second heating step 303 is employed. The content thereof is the same as that of the first heating step 301.

Next, the honeycomb form 50 is fired by the firing device not shown in the drawings.

Also, if the honeycomb form 50 prior to the firing process 40 has a water content of more than 5%, it can also be effectively fired after being dried further by hot air or the like till its water content is less than 5%.

Further, both ends of the honeycomb form 50 are chamfered after firing, and the ceramic honeycomb structure 1 is complete. This chamfering is for repairing cell warping generated by the cutting process 20 after the extrusion process 10.

Also, for reference, from the ceramic form 50, a manufacturing method that allows a plurality of ceramic honeycomb structures 1 can be considered. This is because the number of chamfering operations for each ceramic honeycomb structure 1 would be reduced.

As described above, according to the present embodiment, in a drying process, heating in the heating step and alteration of the disposition of the honeycomb form in the rotating step are repeatedly performed. As a result, deformation of the honeycomb form in the drying process can be controlled even when the honeycomb form has thin wall thicknesses.

In other words, even if a weak honeycomb form 50 after the extrusion process 10 is dried in a state where it is arranged substantially horizontally, deformation of the honeycomb form 50 does not occur.

In addition, the present embodiment shows an example where the drying device 31 includes the transport means 32, the two heating devices 33, and the rotating device 34, and continuous processing is carried out in the drying process 30. Here, although obvious, the present invention is not limited to the continuous process as described in the embodiments. Unlike the present embodiment, the drying device may also comprise only one heating device and one rotating device. In this case, firstly, a heating step wherein the honeycomb form is introduced into the heating device is performed. Next, the honeycomb form is rotated in the rotating device so that its disposition is changed. Further, the honeycomb form is again introduced into the heating device and the heating step carried out. By means of this procedure, the same operational effects as the above embodiment can be attained.

Also, in the present embodiment, in the drying process 30, there are two heating steps and one rotating step. Although obvious, more than two heating steps, and a number of rotating steps between the heating steps can be performed if necessary.

1. A ceramic honeycomb structure manufacturing method comprising:
an extrusion process for forming a honeycomb form having an external shell, partitions arranged within the external shell in a honeycomb formation, and a plurality of cells divided inside the partitions and formed along an axial direction so as to pass through both ends, by extrusion forming a ceramic raw material made by kneading at least a raw material powder and water;
a cutting process for cutting the honeycomb form into predetermined lengths;
a drying process for drying the honeycomb form; and
a firing process for firing the honeycomb form to attain a ceramic honeycomb structure, wherein:
in the drying process, a heating step for applying heat in a state where the honeycomb form is arranged so that its axis is inclined in a direction away from the vertical and the honeycomb form is held stationary in a direction of rotation of the axis, and a rotating step for changing an arrangement of the honeycomb form by rotating the honeycomb form around its axis between each of a plurality of executions of the heating step, are performed.

2. The ceramic honeycomb structure manufacturing method according to claim 1, wherein, in the drying process, the heating step and the rotating step are performed with the honeycomb form arranged so that its axis is substantially horizontal.

3. The ceramic honeycomb structure manufacturing method according to claim 1, wherein, in the rotating step, the honeycomb form is rotated with a range of 90° to 270°.

4. The ceramic honeycomb structure manufacturing method according to claim 1, wherein, in the heating step, the honeycomb form is heated by microwave heating.

5. The ceramic honeycomb structure manufacturing method according to claim 1, wherein, in the heating step, the honeycomb form is heated by high frequency heating.

6. The ceramic honeycomb structure manufacturing method according to claim 1, wherein, when the heating step is performed, the honeycomb form is mounted on a sponge shaped pedestal for supporting part of the outer shell thereof.

7. The ceramic honeycomb structure manufacturing method according to claim 6, wherein the honeycomb form is mounted on the pedestal so that some of the partitions are substantially perpendicular.

8. The ceramic honeycomb structure manufacturing method according to claim 1, wherein the external shell of the honeycomb form has a maximum thickness of 0.8 mm, and the partitions of the honeycomb form have a maximum thickness of 150 μm.

9. A ceramic honeycomb structure manufacturing method comprising:
an extrusion process for forming a honeycomb form having an external shell with a maximum thickness of 0.8 mm, partitions arranged within the external shell in a honeycomb formation with a maximum thickness of 150 μm, and a plurality of cells divided inside the partitions and formed along an axial direction so as to pass through both ends, by extrusion forming a ceramic raw material made by kneading at least a raw material powder and water;
a cutting process for cutting the honeycomb form into predetermined lengths;
a drying process for drying the honeycomb form; and
a firing process for firing the honeycomb form to attain a ceramic honeycomb structure, wherein:
in the drying process, a heating step for performing microwave heating in a state where the honeycomb form is mounted on a sponge shaped pedestal for supporting part of the external shell of the honeycomb form so that its axis is substantially horizontal and the honeycomb form is held stationary in a direction of rotation of the axis, and a rotating step for changing an arrangement of the honeycomb form by rotating the honeycomb form around its axis between each of a plurality of executions of the heating step, are performed.

10. A ceramic honeycomb structure drying device for drying a honeycomb form having an external shell, partitions arranged within the external shell in a honeycomb formation, and a plurality of cells divided inside the partitions and formed along the axial direction so as to pass through both ends, comprising:
transport means for conveying the honeycomb form by mounting the honeycomb form on a pedestal that supports part of its external shell so that the axis of the honeycomb form is substantially horizontal;
a heating device for heating the honeycomb form by means of microwave heating; and
a rotating device for changing the arrangement of honeycomb form by rotating it around the its axis, wherein:
the honeycomb form is sequentially transported to the heating device and the rotating device by the transport means, a heating step for applying heat in a state where the honeycomb form is held stationary in the direction of rotation of its axis in the heating device, and a rotating step for rotating the honeycomb form in the rotating device between each of a plurality of executions of the heating step, are performed.

11. The ceramic honeycomb structure manufacturing method according to claim 10, wherein the drying device has a plurality of heating devices, and the heating devices and rotating device are alternately disposed on a conveyor line of the transport device.
